(19) United States
(12) Patent Application Publication
(10) Pub. No.: US 2024/0079226 A1
(43) Pub. Date: Mar. 7, 2024

(54) COMPACT LASER ION SOURCE APPARATUS AND METHOD

(71) Applicant: Atomic Energy Of Canada Limited / Énergie Atomique Du Canada Limitée, Chalk River (CA)

(72) Inventors: Ankur Chaudhuri, Chalk River (CA); Liqian Li, Chalk River (CA); James Johnston, Chalk River (CA); Martin-Lee Cusick, Chalk River (CA)

(21) Appl. No.: 18/268,649

(22) PCT Filed: Dec. 21, 2021
(86) PCT No.: PCT/CA2021/051856

§ 371 Date: Jun. 21, 2023

Related U.S. Application Data
(60) Provisional application No. 63/128,225, filed on Dec. 21, 2020.

(51) Int. Cl. H01J 49/40; H01J 49/00; H01J 49/16; H01J 49/24

(52) U.S. Cl. CPC H01J 49/408; H01J 49/0022; H01J 49/164; H01J 49/24

(57) ABSTRACT

An apparatus for and a method of analyzing a sample. A laser section may include a laser arranged to direct a laser beam in a first direction towards the sample. The laser beam ablating and ionizing at least a portion of the sample to generate ions. An ion source section may include a sample holder for holding the sample. At least one component is arranged to apply an electric field for extracting at least a portion of the ions to form an ion beam traveling in a second direction. A time-of-flight section may include a detector arranged to receive the ion beam.

### CROSS-REFERENCE TO RELATED APPLICATION

This application claims priority to U.S. Provisional Application No. 63/128,225 filed on Dec. 21, 2020, the entire contents of which are hereby incorporated herein by reference.

### FIELD

The present disclosure relates generally to a compact ion source designed for in situ mass spectrometry of solid samples.

### INTRODUCTION

The following paragraphs are not an admission that anything discussed in them is prior art or part of the knowledge of persons skilled in the art.

A number of techniques can be used to create gas phase ions from solid sample for mass spectrometry application. In some techniques, solid sample analysis involves several chemical dissolution and purification steps. After that process, the samples are introduced into any suitable ion source for ionization. In some techniques, solid samples can be directly ionized by employing particle bombardment where a beam of high energy atoms or ions strike the solid surface to create ions. In some techniques, a high power laser can be focused on a solid sample surface for simultaneous ablation and ionization of the solid sample.

U.S. Pat. No. 6,169,288 describes a laser ablation type ion source including vacuum chambers provided with a retaining section for holding a solid raw material for the generation of ions, an ion extracting electrode, an ion accelerating electrode, and a mass spectrograph for ion separation. The ion source also includes a laser beam source for injecting a laser beam of high density into the vacuum chamber.

Canadian Patent No. 2,527,886 describes atmospheric pressure, intermediate pressure and vacuum laser desorption ionization methods and ion sources that are configured to increase ionization efficiency and the efficiency of transmitting ions to a mass to charge analyzer or ion mobility analyzer.

### BRIEF DESCRIPTION OF THE DRAWINGS

The drawings included herewith are for illustrating various examples of apparatuses and methods of the present disclosure and are not intended to limit the scope of what is taught in any way.

FIG. 1 is a schematic view of an apparatus including a laser section, an ion source section, and a time-of-flight section.

FIGS. 2A and 2B are front and back views, respectively, of a vacuum chamber with radially-directed flanged ports.

FIG. 3A shows components of the ion source section, and FIG. 3B shows components of the ion source and time-of-flight sections.

FIG. 4 shows components of the ion source section.

FIG. 5 shows a sample holder.

FIG. 6 shows a method.

FIG. 7 is a measured time-of-flight spectrum.

FIGS. 8, 9 and 10 are photographs of an exemplary apparatus.

FIG. 11 shows an exemplary simulation of ion trajectories and generated equipotential lines.

FIG. 12 shows an experimental set-up for a sample position optimization experiment.

FIG. 13 shows time-of-flight spectrum at various sample positions for the optimization experiment.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

The teachings described herein relate to a compact laser ion source for time-of-flight mass spectrometry.

A mass spectrometer is an analytical instrument that measures the mass-to-charge ratios of ionized atoms or molecules. Generally, a mass spectrometer can only measure gas phase ions. Hence, samples in solid or liquid states are required to be at least partially transformed into gas phase ions before they can be analyzed in a mass spectrometer.

Traditionally, mass spectrometry can require extensive sample preparation procedures for solid samples. This can be an obstacle to using a field-portable mass spectrometer for in situ analysis of solid environmental samples. The sample preparation method typically involves several dissolution and purification steps, performed by trained chemists with specialized supplies, before introduction of the sample into a mass spectrometer for ionization and mass analysis. This can be further complicated by logistical challenges and significant costs arising from associated waste generation and disposal issues.

It is desirable to simplify the sample preparation and ionization method of solid samples for in situ mass spectrometer applications. It is also desirable to have a compact transportable ion source that is easy to operate, and does not require any consumable for the in-field application.

Solid samples can be directly ionized, i.e. without chemical dissolution, using a high power laser. A high power laser beam can be focused on a solid sample surface for simultaneous ablation and ionization of the sample. However, a set of aligning mirrors can be required to direct the laser beam onto the solid sample. The laser alignment and monitoring of high power laser beam can be an operational challenge for in-field application. Existing laser ion sources can be difficult to optically adjust, and heavy and cumbersome, and hence not suitable for portable use.

Teachings of the present disclosure may overcome limitations of existing laser ion sources. A compact laser ion source is designed for in situ mass spectrometer application of samples. A short-pulsed, high peak-power laser beam is focused on the surface of the solid sample for both ablation and ionization of the sample. An ion extraction and focusing system is designed to transfer the laser produced gas-phase ions to the mass spectrometer. In order to develop simple and easy-to-use laser control for in-field application, an orthogonal ion acceleration scheme is implemented, i.e. the ion beam generated by the laser pulse is extracted and accelerated along the direction orthogonal to that of the laser beam. This design scheme allows development of a compact laser alignment geometry.

In particular, a compact laser ion source is designed for in situ mass spectrometer application of solid samples. The laser alignment system is designed in such a way that the laser beam can be focused on various locations along the sample, even during data acquisition. The laser is mounted to a remote controlled motorized platform, with laser beam and sample monitoring provided by an angled high definition camera. This allows for measurements to be taken on different parts of the sample without the need to reposition the sample, and hence without the need to open up the laser protection enclosure. Unlike existing solutions, this system has the ability to align the laser without mirrors. This system does not require the opening up of the laser-safety enclosure during laser alignment and measurement. This system has the ability to extract and focus the laser generated ions using a compact ion extraction and focusing electrode design.

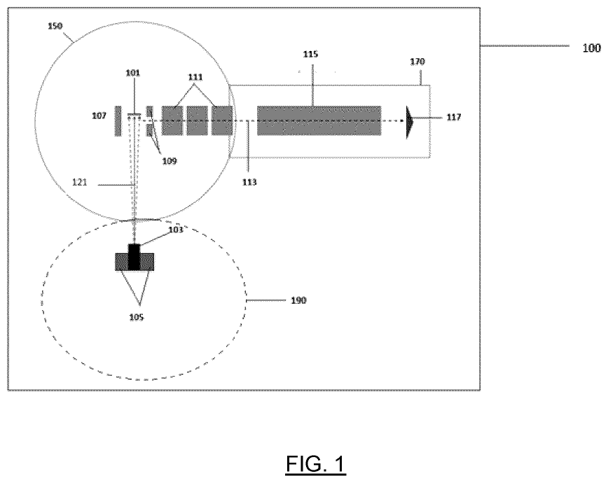

Referring to FIG. 1, an example of a compact laser ion source apparatus is shown generally at reference numeral 100. In the example illustrated, the apparatus 100 includes: an ion source section 150 housed inside a spherical vacuum chamber; a time-of-flight section 170 housed inside a vacuum pipe; and a laser section 190. The spherical vacuum chamber of the section 150 and the vacuum pipe of the section 170 can be connected, and hence form a single vacuum containment unit. During operation, the ion source section 150 and the time-of-flight section 170 can be kept, for example, below a pressure of 5×10⁻⁶ mbar. The laser section 190 can be located outside of this vacuum containment unit. In some examples, the ion source section 150, the time-of-flight section 170 and the laser section 190 can be housed together in a single portable unit.

In the example illustrated, the laser section 190 includes a laser 103 mounted on a movable laser platform 105. The ion source section 150 includes a sample holder 101, a repeller plate 107, an extraction plate 109 and an einzel lens electrode 111. The time-of-flight section 170 includes a time-of-flight electrode 115 and a time-of-flight detector 117. Also shown in FIG. 1 is a laser beam 121, which travels from the laser 103 to the sample on the sample holder 101, and an ion beam 113, which travels from the sample on the sample holder 101 to the time-of-flight detector 117.

The design of the electrode configuration of the ion source section and the time-of-flight section was performed using SIMION® software, version 8.1. An example of simulated ion trajectories of randomly created 239Pu+ ions from the sample position to time-of-flight detector (shown by the thickened, solid dark grey region), and the equipotential lines (shown by fine black lines) generated by the simulated voltages is shown in FIG. 11. In the example illustrated in FIG. 11, the repeller plate was simulated with an electric potential of +1000 V, the extraction plate was simulated with an electric potential of −1000 V, the first and the third electrodes of Einzel lens were simulated with an electric potential at −500 V, the second electrode of Einzel lens was simulated with an electric potential at −1500 V, and time-of-flight electrode was simulated with an electric potential at −1000 V. Although the simulation did not account for the laser ionization process, these simulated electrical potential values provided the initially applied electric potential values for commissioning test of compact laser ion source.

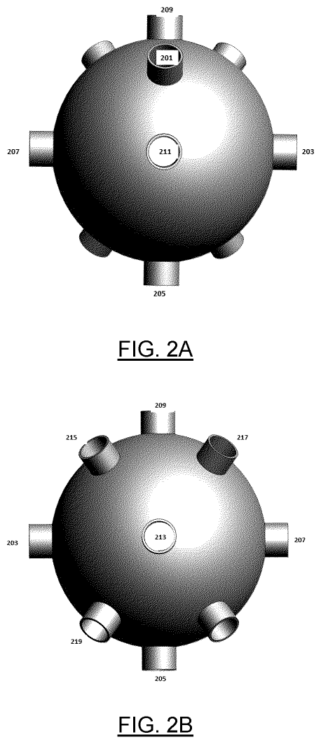

In some examples, the spherical vacuum chamber 150 can take the form of the structure shown in FIGS. 2A and 2B, which can be a commercially available 12″ diameter spherical vacuum housing (SP1200S™, Kurt J. Lesker Company, Pittsburgh, PA). This spherical chamber is made from stainless steel, and capable of reaching ultra-high vacuum (UHV) levels. The example illustrated has 11 radially-directed conflat flanged ports. In the example illustrated, these ports are: an optical view port 209; a port 203 to attach the time-of-flight section 170; a base support port 205; an electrode support and SHV feedthrough port 207; a camera port 201; a laser port 211; a sample holder mounting port 213; a vacuum gauge port 215; a vacuum hose port 217; and a HV feedthrough port 219. The unlabeled port in FIG. 2 can be unused and plugged by a blank flange.

In some examples, a vacuum pump is attached to the vacuum hose port 217 using a vacuum hose to maintain the vacuum environment within the vacuum chamber 150. During operation, the pressure within the vacuum chamber can be lower than 5×10⁻⁶ mbar to avoid electrical discharge.

In some examples, a vacuum gauge is attached to the vacuum gauge port 215, which provides a readout on the pressure inside the vacuum chamber. The gauge can be an analog physical gauge. In other examples, the gauge can be digital and may be connected to a computer to facilitate the remote monitoring of the vacuum pressure.

In some examples, a conflat flanged port that supports the ion source electrode structure and SHV feedthroughs to provide electrical connection to ion source electrodes is mounted on port 207.

In some examples, the camera is connected to the mounting camera port 201 to facilitate the capturing and remote viewing of the activity taking place within the vacuum chamber. In particular, the camera can be used for alignment and remote monitoring of the laser spot on the sample during the operation.

In some examples, the optical view port 209 allows for the operator or any other person to view the inside of the vacuum chamber which may facilitate sample setup.

In some examples, a laser transmission window is mounted on the laser port 211, which facilitates the transmission of laser beam 121 from the laser 103 to the sample holder 101 while maintaining the vacuum pressure inside the vacuum chamber.

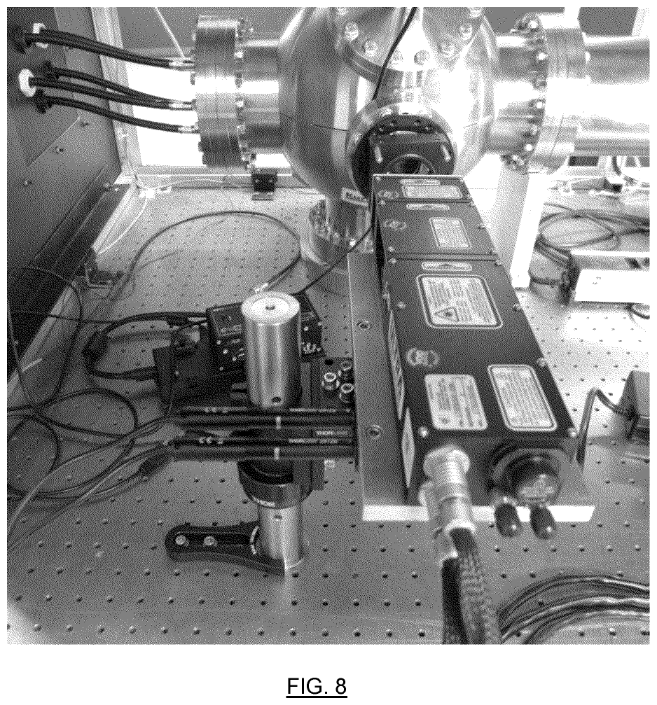

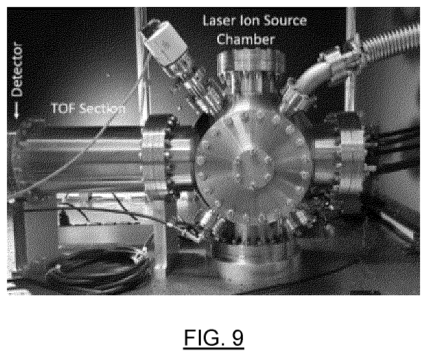

Photos of the vacuum chamber 150 with many of the ports filled with their respective components can be seen in FIGS. 8, 9 and 10.

Referring again to FIG. 1, the laser section 190 can include the laser 103 mounted on the platform 105. In the example illustrated, the laser 103 can be a Q-switched pulsed Nd:YAG laser (ULTRA 100™, Quantel, Bozeman, MT) with the following characteristics: a 55 mJ energy/pulse; a 532 nm wavelength; beam diameter 4 mm; a repetition rate of 20 Hz; and a pulse length of 6.5 ns. Generally, any compact and portable laser which can achieve an approximate power density of irradiation of 6×10⁷ W/cm 2 may be suitable for operation.

The laser beam 121 travels from the laser 103 to the sample holder 101. The laser 103 is aimed at a surface of the sample on the sample holder 101 and configured to ionize and ablate a target region of the surface. In some examples, a lens (not shown) may be placed between the laser 103 and the sample holder 101, with the lens configured to focus the laser beam 121 onto the sample on the sample holder 101. In some examples, the platform 105 may be configured to move within a plane perpendicular to the direction of the laser beam. This configuration can allow the laser beam 121 to be easily moved to target different locations on the sample on the sample holder 101 without requiring the sample itself to be moved. In other examples, the platform 105 can be configured to move in all three directions.

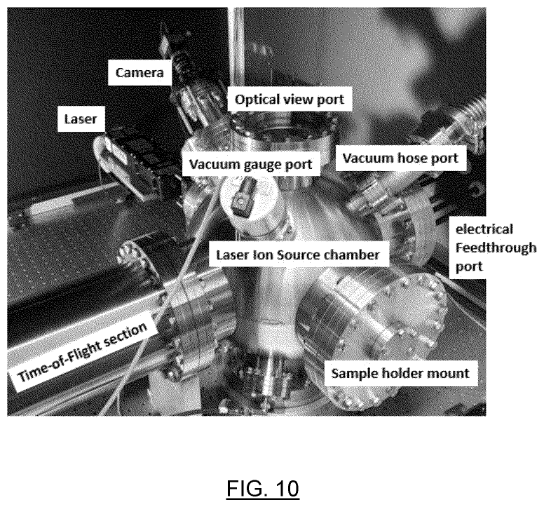

In the example illustrated in FIG. 10, the laser is mounted on a motorized pitch and yaw platform (PY004Z8™, Thorlabs Inc., Newton, NJ) controlled by motors (KDC101™, Thorlabs Inc., Newton, NJ). This may obviate the need for laser alignment mirrors. The camera mounted to the camera port 201 can be used for continuous remote monitoring of the sample condition, and laser spot on the sample during operation. In the example illustrated in FIG. 10, a USB camera (DCC1204C™, Thorlabs Inc., Newton, NJ) is used to remotely monitor the laser spot on the sample.

In some existing systems, the laser is not aimed directly at the sample, but instead reflects off one or more mirrors, which can increases the scope for laser alignment issues. The apparatus and method described herein can minimize alignment issues as well as result in a more compact system to facilitate mobile use. Moreover, when the laser ion source and detector is contained within the vacuum housing shown in FIG. 1, the geometry can ensure that the sample-holder port and the ion-source port are orthogonal to each other, which can facilitate an easy and quick sample change.

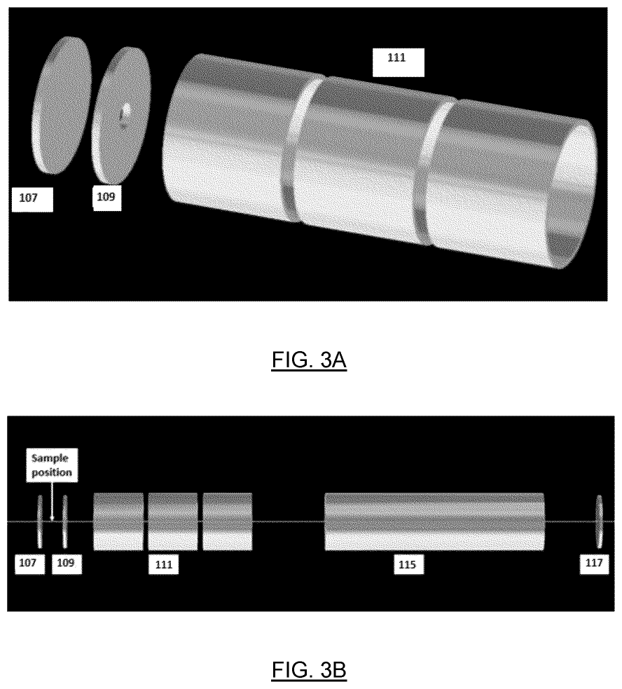

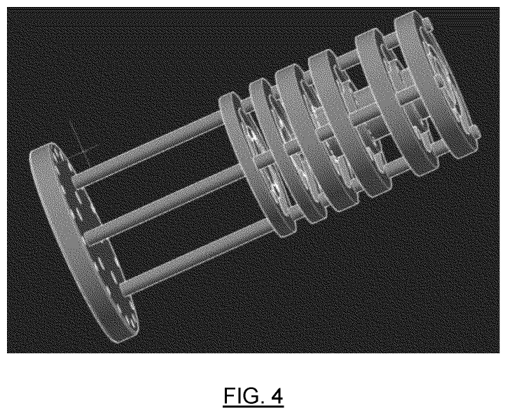

Referring to FIG. 3A, a repeller plate 107, an extraction plate 109, and an einzel lens electrode 111 can be arranged and mounted on a single conflat flanged port of the vacuum chamber, for example, on port 207 (FIGS. 2A and 2B).

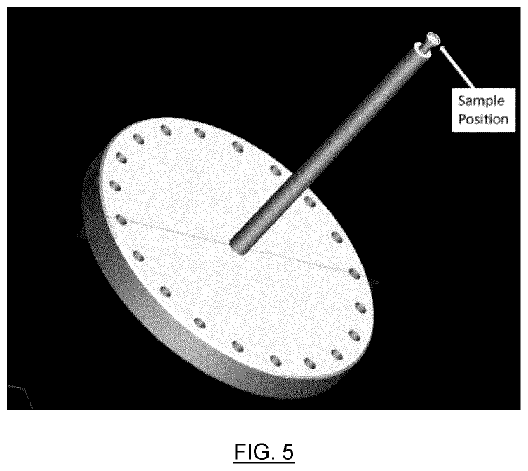

FIG. 4 shows the ion source assembly including the plates, the electrode and a support structure. In the example illustrated, the electrodes are each made of stainless steel and the source assembly is made of aluminum. Boron nitride ceramic can be used for electrical isolation between the electrodes and the support structure. Boron nitride can be selected because of its excellent thermal, chemical, and vacuum stability, which renders it suitable for laser ionization applications. Additionally, five instrumentation feedthroughs can be welded onto the same flange to provide electrical connection to the electrodes. Hence, the ion source electrode structure can be installed inside the vacuum housing as a single flange mounted unit.

Referring again to FIG. 1, after the sample has been ionized and ablated, the resulting ions will be formed into an ion beam 113 by the repeller plate 107 and the extraction plate 109 and directed in a direction orthogonal to the laser beam 121. In the example illustrated, both the repeller plate 107 and the extraction plate 109 are electrically charged, which generates an electric field that forms and directs the ion beam 113. In the example illustrated, the repeller plate 107 and the extraction plate 109 are positioned adjacent to and at opposing sides of the sample holder 101, and both have internal surfaces facing the laser beam 121 that are flat and parallel to the direction of the laser beam 121. This particular geometry generates a nearly linear electric field and directs the ion beam 113 in the orthogonal direction towards the time-of-flight detector 117.

In the example illustrated, the extraction plate 109 has a single, central hole within it that is disposed along the path from the sample holder 101 to the time-of-flight section 170, which enables the ion beam 113 to pass through. In some examples, the repeller plate 107 can be a circular disk with a diameter of 50 mm and can be set with an electric potential at +1150 V. In some examples, the extraction plate 109 can be a circular disk that is the same size as the repeller plate 107, with a circular hole 10 mm in diameter in the center. In some examples, the extraction plate 109 can be set with an electric potential at +1050 V. In some examples, the physical distance between the repeller plate 107 and the extraction plate 109 can be 20 mm.

In the example illustrated, the einzel lens electrode 111 is located between the extraction plate 109 and the time-of-flight electrode 115. As shown, the electrode 111 can have three distinct, hollow cylindrical electrodes arranged in series along the direction of the ion beam 113. The inner diameter and length of each of the electrode can 50 mm and 45 mm, respectively. The gap between the first and second electrodes can be 5 mm, and second and third electrode can be 5 mm. In some examples, the first and the third electrodes are set with an electric potential at −500 V and the second electrode is set with an electric potential at −1500 V. The combination of the physical dimension of electrodes and the applied voltages facilitates the focusing of the ion beam 113 resulting in an efficient transfer of the ions to the time-of-flight section 170.

Generally, the sample holder 101 can place the sample between the repeller plate 107 and the extraction plate 109. In the example illustrated, the sample holder 101 includes a plate and a rod extending from the plate, as shown in FIG. 5. The sample is mounted at the end of the rod, and is positioned midway between the repeller plate 107 and the extraction plate 109. The base can be mounted on a flange. In some examples, the base of the sample holder 101 is mounted onto a conflat flanged port of the vacuum chamber, for example, on port 213 (FIG. 2B), and positioned perpendicularly to the ion source.

With continued reference to FIG. 1, the time-of-flight section 170 can be connected to the port 203 of the laser ion source chamber (FIGS. 2A and 2B), and hence form a single vacuum system. In the example illustrated, the time-of-flight section 170 is arranged longitudinally along the axis of ion beam 113, and orthogonal to the direction of the laser beam 121. In some examples, the time-of-flight section 170 can be housed within a 12″ long beam pipe (for example, conflat full nipple, 12″ length).

In the example illustrated, the time-of-flight section 170 includes a time-of-flight electrode 115 and a time-of-flight detector 117.

Referring to FIG. 3B, the time-of-flight electrode 115 can be a hollow cylindrical electrode with an inner diameter of 50 mm and a length of 200 mm. The gap between the time-of-flight electrode 115 and the nearest electrode of the einzel lens electrode 111 can be 67 mm. In some examples, the time-of-flight electrode 115 can be electrically grounded for transmission of ions to the time-of-flight detector 117. The time-of-flight detector 117 can be placed 50 mm away from the nearest edge of the time-of-flight electrode 115. The detector 117 is arranged to face the ion beam.

In some examples, the time-of-flight detector 117 can be a microchannel plate (MCP) type time-of-flight detector, which is a type of electron multiplier for detecting charged particles. Specifically, the time-of-flight detector 117 can be an Advanced Performance Detector (APD) (30032™, Photonis, France). The detector used was available as a vacuum flange mounted unit with an active MCP diameter of 18 mm. In some examples, the detector can be biased to −2000 V during operation.

In some examples, a pulsed laser is used to generate the pulsed ion beam for time-of-flight measurement. In some examples, a Q-switched pulsed Nd:YAG laser (repetition rate 20 Hz, pulse width 6.5 ns) can be used to generate ion bunches during the time-of-flight measurement. A time-of-flight measurement cycle can be started when the laser pulse generates an ion bunch. The time between the laser emission pulse and the time-of-flight detector output pulse is the time-of-flight.

The flight time (t) of the ion inside a time-of-flight mass spectrometer depends on the energy (E) to which the ion is accelerated, the distance (d) to travel, and its mass-to-charge ratio (m/q). For a singly charged ion, the relationship between these parameters can be given by the following equation:

$$t = \sqrt{\frac{( \frac{m}{q} )}{( \frac{2 E}{{d}^{2}} )}} \qquad ( Eq . 1 )$$

Therefore, if ions of different mass-to-charge ratio travel the same distance under the same accelerating field, their mass-to-charge ratio can be determined by recording a time-of-flight spectrum.

Table 1 below lists a sample that was also used to record time-of-flight (TOF) measurements of ions generated by laser ion source.

TABLE 1
Sample used in TOF Measurements

| Sample Type | Composition | Source |
|---|---|---|
| Copper foil 0.127 mm thick | 99.9% copper | 13380 ™, Alfa Aesar, |
| | | Tewksbury, MA |

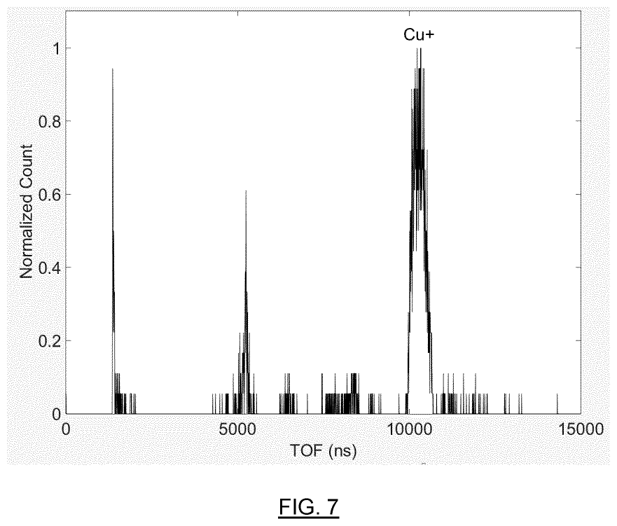

The copper foil was mounted on the top of the sample holder. A small amount of high-temperature putty (Loctite Putty MR 2000™, Acklands Grainger, Canada) was also used to hold the sample foil in place. The recorded TOF spectrum is shown in FIG. 7. A strong peak was observed at 10.3 microseconds, which is from singly-charged copper ions.

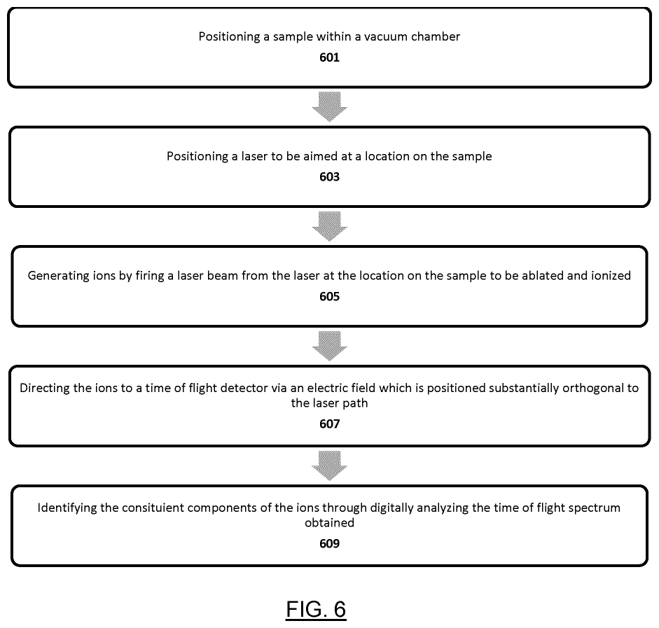

FIG. 6 shows various steps of a method. Firstly, according to step 601, a sample is positioned within a vacuum chamber. Then, according to step 603, a laser is positioned to be aimed at a target location on the surface of the sample. Then, according to step 605, ions are generated by firing a laser beam from the laser at the location on the sample to be ablated and ionized. Next, according to step 607, the ions are directed via an electric field to a time-of-flight detector, which is positioned substantially orthogonal to the laser path. Finally, according to step 609, the constituent components of the ionization particles are identified through digitally analyzing the time-of-flight spectrum obtained.

Regarding step 601, FIG. 5 shows an example of a sample holder. The sample holder flange can be mounted to the port 213. In some examples, the sample can be placed at the center of the spherical chamber 150, and between the repeller plate 107 and extraction plate 109, by adjusting the length of the rod. This configuration allows the sample to directly face the laser beam 121. After installing the sample inside the spherical chamber, the vacuum pump can be started to achieve the operational pressure of, for example, 5×10⁻⁶ mbar inside the vacuum chamber.

In step 603, the laser 103 can emit the pulsed laser beam 121. In some examples, the laser beam 121 can be focused on the surface of the sample by placing a plano-convex lens in the path of and perpendicular to the laser beam 121. In some examples, this lens can be mounted on the laser port 211, and located between the laser 103 and the laser window. Different focal-length plano-convex lens may be used to adjust the spot size of the laser on the sample, and hence adjust the power density of irradiation of laser on the sample surface. The laser spot can be aimed at the sample by using the platform 105, which can be remotely controlled and motorized, and the laser spot can be monitored on the sample using the camera mounted to the camera port 201.

In step 605, the ion beam 113 can be generated by firing the laser beam 121 to the sample. The laser beam simultaneously ablates the sample, and produces laser induced plasma. The positive ions produced in this technique are used for mass spectrometry.

In step 607, direct current (DC) voltages can be applied to the repeller plate 107 and the extraction plate 109 to extract the ion beam 113 towards time-of-flight detector 117. DC voltages are applied to the three electrodes of the einzel lens electrode 111 to focus the ion beam 113 while directing the ion beam 113 towards the time-of-flight detector 117. The time-of-flight electrode 115 can remain electrically grounded for efficient transfer of the ion beam towards the time-of-flight detector 117. Examples of the DC voltages are listed in table 2 below.

TABLE 2
DC voltages of various components

| Electrode | Applied DC voltage | |
|---|---|---|
| Repeller plate | +1150 | V |
| Extraction plate | +1050 | V |
| Einzel lens 1st electrode | −500 | V |
| Einzel lens 2nd electrode | −1500 | V |
| Einzel lens 3rd electrode | −500 | V |
| Time-of-flight electrode | 0 | V |

In step 609, the time-of-flight detector can be biased at −2000 V. When the positive charged ions impinge the microchannel plate of the time-of-flight detector, it can cause electron avalanche that results in detector output signal. In some examples, a multichannel scaler (SR430™, Stanford Research System, Sunnyvale, CA) can be used to record the time between the laser pulse and detector output signal. The time between the laser pulse generating an ion bunch, and that ion bunch arriving at the detector, is recorded and binned as time-of-flight spectrum. In some examples, the time between the MCP signals and the laser pulse signals can be collected and tallied into a histogram. The number of bins of the histogram can be set in 1 k increments from 1 k (1,024) to 16 k (16,384). The bin width can be set at 5 ns. Hence, 8,192 bins of 5 ns covers up to 40.96 μs of time-of-flight measurements. The timing information obtained from the time-of-flight spectrum can be translated into mass information of the ions using Equation 1.

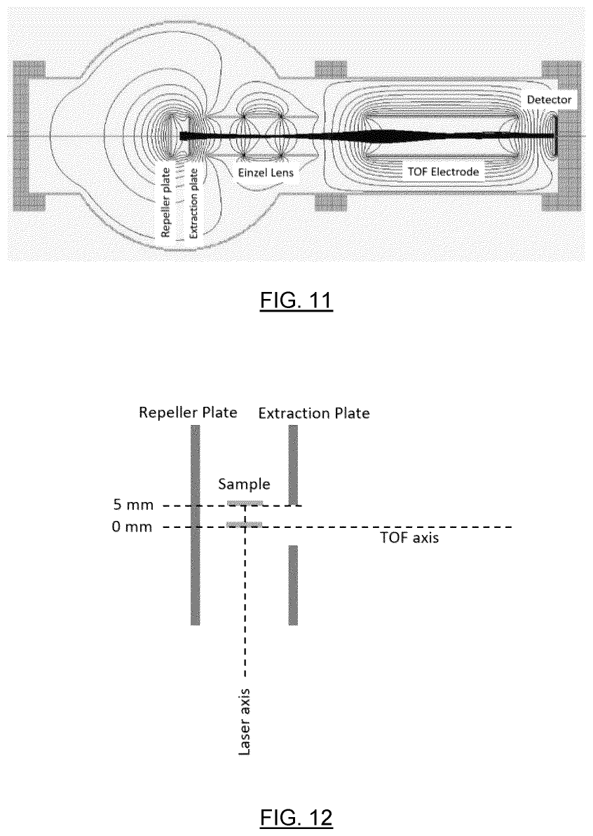

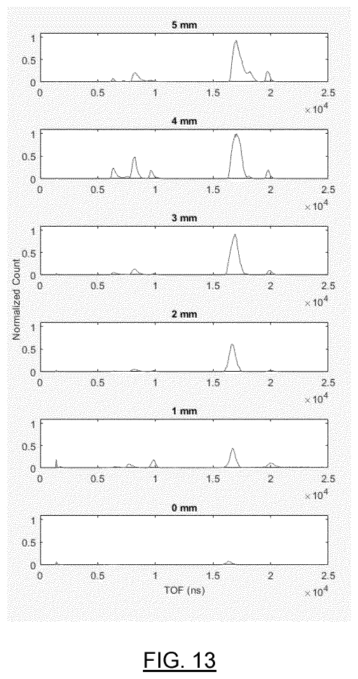

In the example illustrated in FIG. 1, the extraction plate has a circular hole 10 mm in diameter in the center. Hence, the position of the sample along the direction of laser beam is a determination factor of the extraction efficiency and the flight trajectory of the ions. In an experiment to optimize the sample position, a 99.5% tungsten foil (Alfa Aesar Product #10416), glued to the sample holder using high-temperature putty (Loctite Putty MR 2000™, Acklands Grainger, Canada), was positioned in different locations along the direction of laser beam (as shown in FIG. 12). In FIG. 12, the sample position is indicated as ‘0 mm’ when the surface of the sample is aligned with the center of the hole of extraction plate, and indicated as ‘5 mm’ when the surface of the sample is aligned with the edge of the hole of extraction plate. A series of Time-of-Flight measurements were performed by moving the tungsten sample from ‘0 mm’ position to ‘5 mm’ position in increment sizes of 1 mm. The recorded Time-of-Flight spectrum is shown in FIG. 13. The Time-of-Flight spectrum was normalized by dividing it by the maximum values of detector output pulse recorded in that measurement series. It appears from this experiment that the optimum position of the sample is when it is located near the edge of the aperture mm position′) in FIG. 12.

While the above description provides examples of one or more apparatuses or methods, it will be appreciated that other apparatuses or methods may be within the scope of the accompanying claims.

1. An apparatus for analyzing a sample, the apparatus comprising:
a laser section comprising a laser arranged to direct a laser beam in a first direction towards the sample, for ablating and ionizing at least a portion of the sample to generate ions;
an ion source section comprising a sample holder for holding the sample;
at least one component arranged to apply an electric field for extracting at least a portion of the ions to form an ion beam traveling in a second direction; and
a time-of-flight section comprising a detector arranged to receive the ion beam.

2. The apparatus of claim 1, wherein the second direction is non-parallel to the first direction.

3. The apparatus of claim 2, wherein the second direction is generally orthogonal to the first direction.

4. The apparatus of claim 1, wherein the time-of-flight section is arranged so that the detector receives the ion beam while the ion beam travels in the second direction.

5. The apparatus of claim 1, wherein the at least one component comprises a repeller plate that is arranged in the ion source section adjacent to the sample holder, and is configured to receive a positive voltage to generate the electric field.

6. The apparatus of claim 5, wherein the at least one component comprises an extraction plate that is arranged in the ion source section adjacent to the sample holder at an opposing side from the repeller plate, and is configured to receive a positive voltage to generate the electric field.

7. The apparatus of claim 6, wherein the extraction plate comprises a central hole that is arranged for the ion beam to pass through while the ion beam travels in the second direction.

8. The apparatus of claim 1, wherein the at least one component comprises at least one einzel lens electrode that is arranged in the ion source section, and is configured to surround the ion beam and receive a negative voltage to generate the electric field.

9. The apparatus of claim 8, wherein the time-of-flight section comprises a time-of-flight electrode that is arranged to surround the ion beam, and is configured to be electrically grounded.

10. The apparatus of claim 9, wherein the at least one einzel lens electrode is arranged intermediate of the extraction plate and the time-of-flight electrode.

11. The apparatus of claim 1, wherein the detector is configured to be biased with a negative voltage.

12. The apparatus of claim 1, wherein the laser consists of a pulsed laser.

13. The apparatus of claim 12, wherein the detector consists of a time-of-flight detector that is configured to record arrival of an ion bunch generated by a laser pulse.

14. The apparatus of claim 1, wherein the laser is arranged to fire the laser beam directly onto a surface of the sample.

15. The apparatus of claim 1, wherein the laser is mounted on a movable platform.

16. The apparatus of claim 15, wherein the platform is configured for motorized pitch and yaw adjustment.

17. The apparatus of claim 1, comprising a camera for monitoring the laser beam on the sample.

18. The apparatus of claim 1, wherein the ion source section is housed in a vacuum chamber, the time-of-flight section is housed inside a vacuum pipe, and the vacuum chamber and the vacuum pipe are connected to form a single vacuum containment unit.

19. The apparatus of claim 1, wherein the laser section, the ion source section and the time-of-flight section are housed together in a single portable unit.

20. A method of analyzing a sample, the method comprising:
directing a laser beam in a first direction towards the sample;
ablating and ionizing at least a portion of the sample with the laser beam to generate ions;
providing an electric field to extract at least a portion of the ions to form an ion beam traveling in a second direction; and
receiving the ion beam at a detector.

21-43. (canceled)
